(19) United States
(12) Patent Application Publication
(10) Pub. No.: US 2017/0127445 A1
(43) Pub. Date: May 4, 2017

(54) APPARATUS AND METHOD FOR CONTROLLING CONNECTION INTERVAL IN WIRELESS COMMUNICATION SYSTEM SUPPORTING BLUETOOTH SCHEME

(71) Applicants: Samsung Electronics Co., Ltd, Gyeonggi-do (KR); Seoul National University R&DB Foundation, Seoul (KR)

(72) Inventors: Tae-Seop Lee, Seoul (KR); Sae-Woong Bahk, Seoul (KR); Yong-Seok Park, Seoul (KR); Soo-Young Jang, Gyeonggi-do (KR)

(21) Appl. No.: 15/344,498

(22) Filed: Nov. 4, 2016

(30) Foreign Application Priority Data
Nov. 4, 2015 (KR) 10-2015-0154526

(51) Int. Cl. H04W 74/08; H04L 12/26; H04W 76/02; H04W 4/00

(52) U.S. Cl. CPC H04W 74/0808; H04W 4/005; H04W 4/008; H04L 43/0864; H04W 76/028

(57) ABSTRACT

The present disclosure relates to a sensor network, machine type communication (MTC), machine-to-machine (M2M) communication, and technology for internet of things (IoT). The present disclosure may be applied to intelligent services based on the above technologies, such as smart home, smart building, smart city, smart car, connected car, health care, digital education, smart retail, security and safety services. The present disclosure includes a method for controlling a connection interval (CI) by a device in a wireless communication system supporting a Bluetooth scheme. The method includes detecting channel status and controlling a CI for a connection that is established between the device and other device based on the channel status, wherein the CI denotes an interval during which data packet transmission and data packet reception between the device and the other device are possible.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 4, 2015 assigned Serial No. 10-2015-0154526, the entire disclosure of which is incorporated herein by reference.

### TECHNICAL FIELD

The present disclosure relates to an apparatus and method for controlling a connection interval (CI) in a wireless communication system supporting a Bluetooth scheme, and more particularly, to an apparatus and method for controlling a CI based on channel status in a wireless communication system supporting a Bluetooth scheme.

### BACKGROUND

The Internet, which is a human centered connectivity network where humans generate and consume information, is now evolving to the internet of things (IoT) where distributed entities, such as things, exchange and process information without human intervention. The internet of everything (IoE), which is a combination of the IoT technology and the big data processing technology through connection with a cloud server, has emerged.

As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

Machine type communication is rapidly evolving from an M2M communication concept which supports communication between people and things, or between things, based on a mobile communication network into a concept of interacting with all information of real and virtual worlds as well as things while extending its area to the Internet. Namely, the M2M communication that enables the intelligent communication between people and things, or between things, at anytime and anywhere in real time in a stable and convenient manner is extending its area to IoT while connecting all surrounding things through the Internet.

The IoT refers to a technology of connecting various types of things, which have a sensor and a communication function embedded therein, to the Internet. Here, the things include various embedded systems (a computer system of an electronic device such as a smart phone), such as home appliances, a mobile device, wearable computers, etc. The things connected to the IoT have to be connected to an internet based on a unique internet protocol (IP) address by which the things can be identified, and may have sensors embedded therein for acquiring information from an external environment.

Recently, IoT has been rapidly developed, so a Bluetooth scheme, specially, a Bluetooth scheme which supports a Bluetooth low energy (BLE) mode has been attracted. Generally, a user may control devices to which a BLE mode is applied using a portable terminal, e.g., a smart phone, so devices to which a BLE mode is applied has been increased.

An operation for transmitting and receiving a data packet in a conventional wireless communication system supporting a BLE mode will be described with reference to FIG. 1.

FIG. 1 schematically illustrates an operation for transmitting and receiving a data packet in a conventional wireless communication system supporting a BLE mode.

Referring to FIG. 1, an initiator performs a scan operation based on a preset scan interval. The initiator is a master BLE device 111, and the scan operation is performed during a preset scan window.

Upon detecting that traffic is arrived, an advertiser performs an advertising event operation based on an advertising interval. Here, the advertiser is a slave BLE device 113.

Upon detecting the advertiser while performing the scan operation based on the scan interval, the initiator transmits a connection request message to the advertiser.

After the connection request message is received from the initiator, a connection is established between the initiator and the advertiser. According to the connection establishment, the initiator, i.e., the master BLE device 111 and the advertiser, i.e., the slave BLE device 113 performs a data transmitting operation and a connection maintaining operation corresponding to a preset CI TCI. Here, a CI TCI denotes an interval during which data transmission and data reception between two BLE devices are possible in a connection which is established between the two BLE devices.

A data transmitting operation and a connection maintaining operation which are performed between the master BLE device 111 and the slave BLE device 113 will be described below.

If a data packet to be transmitted occurs, the master BLE device 111 transmits the data packet through a preset data channel, so a connection event between the master BLE device 111 and the slave BLE device 113 is started. If a data packet to be transmitted occurs, the slave BLE device 113 also transmits the data packet through the data channel. If there is no data to be transmitted in the master BLE device 111 and the slave BLE device 113, the connection event is terminated. In FIG. 1, for convenience, it will be noted that a data packet, i.e., a master data packet which is transmitted in the master BLE device 111 is illustrated as “M”, and a data packet, i.e., a slave data packet which is transmitted in the slave BLE device 113 is illustrated as “S”.

In FIG. 1, if there is no data to be transmitted in the master BLE device 111 and the slave BLE device 113, the connection event is terminated. However, if a cyclic redundancy check (CRC) error successively occurs preset times, e.g., two times, the connection event may be terminated.

Meanwhile, a connection event does not occur in a specific CI. In this case, each of the master BLE device 111 and the slave BLE device 113 transmits a null packet to maintain a connection which is established between the master BLE device 111 and the slave BLE device 113. In FIG. 1, for convenience, it will be noted that the null packet is illustrated as “N”. A data channel which is used every CI may be hopped based on a preset channel hopping scheme.

Meanwhile, if null packets are successively lost between the master BLE device 111 and the slave BLE device 113, supervision timeout may occur. The supervision timeout is used for checking whether a connection between two BLE devices is released. If the master BLE device 111 and the slave BLE device 113 do not receive any effective data packet during a preset supervision timeout period TST, supervision timeout occurs in the master BLE device 111 and the slave BLE device 113.

If the supervision timeout occurs, a connection which is established between the master BLE device 111 and the slave BLE device 113 is released, so a connection reestablishing process for reestablishing a connection is performed between the master BLE device 111 and the slave BLE device 113.

Meanwhile, a BLE mode proposed in the Bluetooth scheme is a mode which is proposed in a case assuming a channel which is not affected by an error, i.e., an error free channel. That is, since the Bluetooth scheme considers only a case that there is a need for short range connectivity such as a case that a wearable device is used, relatively good channel status, e.g., channel status corresponding to a relatively high received signal strength indicator (RSSI) may be maintained, so an operation in the BLE mode is performed based on stable and good link quality.

Recently, the Bluetooth has been actively used in a case that needs to support long range connectivity such as a smart home network, a mesh network, and the like, so efficiency of an operation in a BLE mode which is proposed by considering an error free channel may be decreased due to bad channel status between two BLE devices.

For example, as described in FIG. 1, a connection which is established between two BLE devices in a BLE mode is maintained corresponding to a CI, and the CI in a BLE mode of the current BLE scheme is used as a preset value which is fixed corresponding to a system situation. Here, the CI is determined based on a BLE mode assuming an error-free channel. As described above, if long range connectivity needs to be supported like in a smart home network, a mesh network, and the like, an error-free channel may not be guaranteed. So, if an operation for transmitting and receiving a data packet is performed based on a CI which is determined in the BLE mode assuming the error-free channel, the operation may not be normally performed. This abnormal operation may degrade total system performance. That is, the CI may be an important parameter for determining performance of a wireless communication system in which the BLE mode is used. The reason will be described below.

Firstly, in the BLE mode, after establishing a connection, two BLE devices operates in a sleep state in order to decrease energy which is consumed for maintaining the established connection unless a connection event occurs. If the connection event occurs, the two BLE devices wake up based on a CI to transmit and receive a data packet. So, if the CI is set to a lengthy value, delay may occur in processing a connection event. Alternatively, if the CI is set to a value which is too short, power consumption due to unnecessary wake up may be increased. So, the CI becomes an important parameter for determining total system performance.

Currently, a Bluetooth scheme defines a scheme for determining a CI that the CI is determined as an arbitrary value within a range from 7.5 milliseconds to 10.24 milliseconds, and does not define any specific scheme for determining the CI. Specially, the CI which is determined as the arbitrary value within the range from 7.5 milliseconds to 10.24 milliseconds is based on an error free channel, and the current Bluetooth scheme does not define any scheme for determining a CI in a case that an error free channel is not guaranteed.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide an apparatus and method for controlling a connection interval (CI) in a wireless communication system supporting a Bluetooth scheme.

Another aspect of the present disclosure is to propose an apparatus and method for adaptively controlling a CI in a wireless communication system supporting a Bluetooth scheme.

Another aspect of the present disclosure is to propose an apparatus and method for adaptively controlling a CI based on channel status in a wireless communication system supporting a Bluetooth scheme.

Another aspect of the present disclosure is to propose an apparatus and method for controlling a CI thereby decreasing power consumption of a BLE device which operates in a BLE mode in a wireless communication system supporting a Bluetooth scheme.

Another aspect of the present disclosure is to propose an apparatus and method for controlling a CI thereby guaranteeing a seamless connection among BLE devices which operate in a BLE mode in a wireless communication system supporting a Bluetooth scheme.

In accordance with an aspect of the present disclosure, a method for controlling a connection interval (CI) by a device in a wireless communication system supporting a Bluetooth scheme is provided. The method includes detecting channel status; and controlling a CI for a connection which is established between the device and other device based on the channel status, wherein the CI denotes an interval during which data packet transmission and data packet reception between the device and the other device are possible.

In accordance with another aspect of the present disclosure, a device in a wireless communication system supporting a Bluetooth scheme is provided. The device includes a processor configured to perform an operation of detecting channel status, and perform an operation of controlling a connection interval (CI) for a connection which is established between the device and other device based on the channel status, wherein the CI denotes an interval during which data packet transmission and data packet reception between the device and the other device are possible.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates an operation for transmitting and receiving a data packet in a conventional wireless communication system supporting a BLE mode;

FIG. 2 schematically illustrates a channel environment in a case that a fixed CI is used in a wireless communication system supporting a BLE mode according to an embodiment of the present disclosure;

FIG. 3 schematically illustrates an inner structure of a BLE device in a wireless communication system supporting a Bluetooth scheme according to an embodiment of the present disclosure;

FIG. 4 schematically illustrates an inner structure of a link layer in a wireless communication system supporting a Bluetooth scheme according to an embodiment of the present disclosure;

FIG. 5 schematically illustrates an inner structure of an L2CAP layer in a wireless communication system supporting a Bluetooth scheme according to an embodiment of the present disclosure;

FIG. 6 schematically illustrates a process for estimating a PER in a wireless communication system supporting a Bluetooth scheme according to an embodiment of the present disclosure;

FIG. 7 schematically illustrates relation between a retransmission count for a data packet and RTT for the data packet in a wireless communication system supporting a Bluetooth scheme according to an embodiment of the present disclosure;

FIG. 8 schematically illustrates an example of a process for controlling a CI in a wireless communication system supporting a Bluetooth scheme according to an embodiment of the present disclosure;

FIG. 9 schematically illustrates another example of a process for controlling a CI in a wireless communication system supporting a Bluetooth scheme according to an embodiment of the present disclosure;

FIG. 10 schematically illustrates a scheme for detecting an average supervision timeout period according to a CI in a wireless communication system supporting a Bluetooth scheme according to an embodiment of the present disclosure;

FIG. 11 schematically illustrates power which is averagely consumed for maintaining a connection according to a CI in a BLE device in a wireless communication system supporting a Bluetooth scheme according to an embodiment of the present disclosure;

FIG. 12 schematically illustrates an example of a simulation result according to a scheme for controlling a CI in a wireless communication system supporting a Bluetooth scheme according to an embodiment of the present disclosure;

FIG. 13 schematically illustrates another example of a simulation result according to a scheme for controlling a CI in a wireless communication system supporting a Bluetooth scheme according to an embodiment of the present disclosure;

FIG. 14 schematically illustrates still another example of a simulation result according to a scheme for controlling a CI in a wireless communication system supporting a Bluetooth scheme according to an embodiment of the present disclosure;

FIG. 15 schematically illustrates relation between a measured PER and an estimated PER in a wireless communication system supporting a Bluetooth scheme according to an embodiment of the present disclosure;

FIG. 16 schematically illustrates still another example of a simulation result according to a scheme for controlling a CI in a wireless communication system supporting a Bluetooth scheme according to an embodiment of the present disclosure;

FIG. 17 schematically illustrates an inner structure of a master BLE device in a wireless communication system supporting a Bluetooth scheme according to an embodiment of the present disclosure; and

FIG. 18 schematically illustrates an inner structure of a slave BLE device in a wireless communication system supporting a Bluetooth scheme according to an embodiment of the present disclosure.

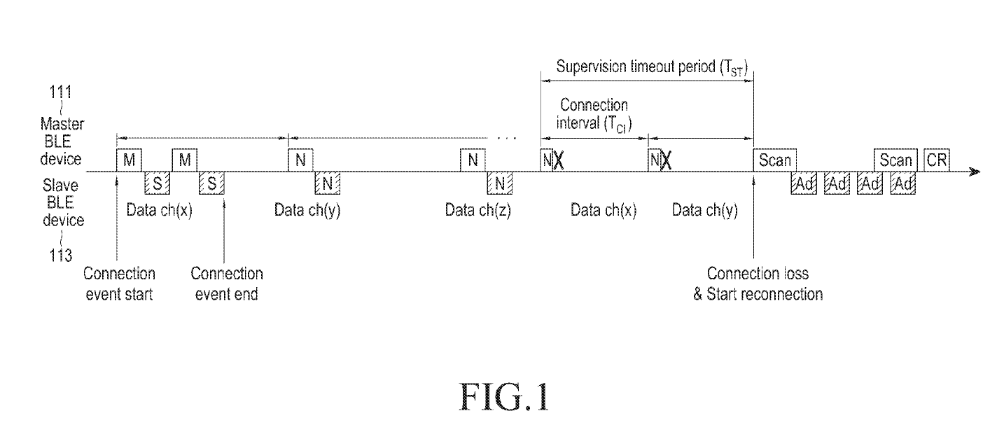

Throughout the drawings, it should be noted that like reference numbers are used to depict the same or similar elements, features, and structures.

### DETAILED DESCRIPTION

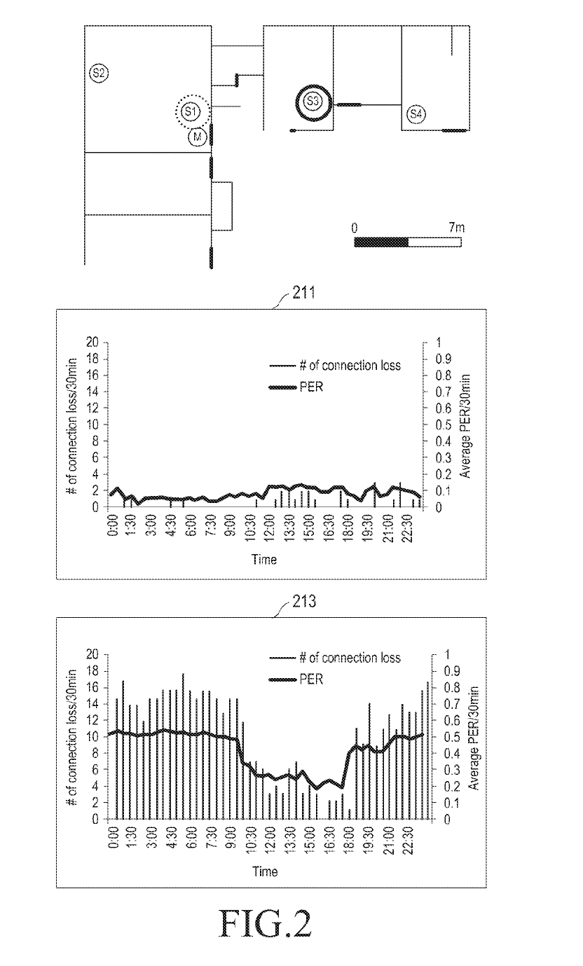

FIGS. 2 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing various embodiments only and is not intended to be limiting. As used herein, the singular forms are intended to include the plural forms as well, unless the context clearly indicates otherwise. It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology.

According to various embodiments of the present disclosure, an electronic device may include communication functionality. For example, an electronic device may be a smart phone, a tablet personal computer (PC), a mobile phone, a video phone, an e-book reader, a desktop PC, a laptop PC, a netbook PC, a personal digital assistant (PDA), a portable multimedia player (PMP), an mp3 player, a mobile medical device, a camera, a wearable device (e.g., a head-mounted device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., magnetic resonance angiography (MRA) device, a magnetic resonance imaging (MRI) device, computed tomography (CT) device, an imaging device, or an ultrasonic device), a navigation device, a global positioning system (GPS) receiver, an event data recorder (EDR), a flight data recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, for example, each of a master Bluetooth low energy (BLE) device and a slave BLE device may be an electronic device.

An embodiment of the present disclosure proposes an apparatus and method for controlling a connection interval (CI) in a wireless communication system supporting a Bluetooth scheme.

An embodiment of the present disclosure proposes an apparatus and method for adaptively controlling a CI in a wireless communication system supporting a Bluetooth scheme.

An embodiment of the present disclosure proposes an apparatus and method for adaptively controlling a CI based on channel status in a wireless communication system supporting a Bluetooth scheme.

An embodiment of the present disclosure proposes an apparatus and method for controlling a CI thereby decreasing power consumption of a BLE device which operates in a BLE mode in a wireless communication system supporting a Bluetooth scheme.

An embodiment of the present disclosure proposes an apparatus and method for controlling a CI thereby guaranteeing a seamless connection among BLE devices which operate in a BLE mode in a wireless communication system supporting a Bluetooth scheme.

A method and apparatus proposed in various embodiments of the present disclosure may be applied to various communication systems such as a long term evolution (LTE) mobile communication system, an LTE-advanced (LTE-A) mobile communication system, a licensed-assisted access (LAA)-LTE mobile communication system, a high speed downlink packet access (HSDPA) mobile communication system, a high speed uplink packet access (HSDPA) mobile communication system, a high rate packet data (HRPD) mobile communication system proposed in a 3rd generation project partnership 2 (3GPP2), a wideband code division multiple access (WCDMA) mobile communication system proposed in the 3GPP2, a code division multiple access (CDMA) mobile communication system proposed in the 3GPP2, an institute of electrical and electronics engineers (IEEE) 802.16m communication system, an IEEE 802.16e communication system, an evolved packet system (EPS), and a mobile internet protocol (Mobile IP) system and/or the like.

A channel environment in a case that a fixed CI is used in a wireless communication system supporting a BLE mode according to an embodiment of the present disclosure will be described with reference to FIG. 2.

FIG. 2 schematically illustrates a channel environment in a case that a fixed CI is used in a wireless communication system supporting a BLE mode according to an embodiment of the present disclosure.

Referring to FIG. 2, the wireless communication system assumes a smart home network which should support long range connectivity, and it will be assumed that there are a master BLE device and a plurality of slave BLE devices, e.g., four slave BLE devices, e.g., a slave BLE device 1, a slave BLE device 2, a slave BLE device 3, and a slave BLE device 4. For convenience, in FIG. 2, it will be noted that the master BLE device is illustrated as “M”, and the slave BLE device 1, the slave BLE device 2, the slave BLE device 3, and the slave BLE device 4 are illustrated as “S1”, “S2”, “S3”, and “S4”, respectively.

If there are the master BLE device, the slave BLE device 1, the slave BLE device 2, the slave BLE device 3, and the slave BLE device 4 as illustrated in FIG. 2, it will be understood that channel status 211 of the slave BLE device 1 is relatively good, and channel status 213 of the slave BLE device 3 is relatively bad. That is, the slave BLE device 1 is very close to the master BLE device, so the channel status 211 is relatively good, and the slave BLE device 3 is relatively far from the master BLE device, so the channel status 213 is relatively bad.

In FIG. 2, a vertical axis in each of graphs indicating the channel status 211 of the slave BLE device 1 and the channel status 213 of the slave BLE device 3 indicates the number of times connection loss occurs during preset time, e.g., 30 minutes, i.e., the number of times connection release occurs and an average packet error rate (PER) during the preset time. In FIG. 2, a horizontal axis in each of the graphs indicating the channel status 211 of the slave BLE device 1 and the channel status 213 of the slave BLE device 3 indicates time.

Further, it will be noted that the channel status 211 of the slave BLE device 1 and the channel status 213 of the slave BLE device 3 as described in FIG. 2 are acquired in a case that a supervision timeout interval TST is set to 6 seconds, and a CI T CI is set to 1.5 sec. Here, the CI T CI denotes an interval during which data transmission and data reception between two BLE devices are possible in a connection which is established between the two BLE devices. Further, supervision timeout is used for checking whether a connection between two BLE devices is released, and supervision timeout occurs in the two BLE devices if the two BLE devices do not receive any effective data packet during a preset supervision timeout interval TST.

In FIG. 2, channel status is a PER, however, it will be understood by those of ordinary skill in the art that the channel status may be expressed using various parameters such as received signal code power (RSCP), reference signal received power (RSRP), reference signal received quality (RSRQ), a carrier-to-interference noise ratio (CINR), a signal-to-noise ratio (SNR), a block error rate (BLER), a received signal strength indicator (RSSI), and the like.

As described in FIG. 2, a case that connection loss occurs, i.e., a case that a connection is released may frequently occur if slave BLE devices of which channel status is bad use a CI which is determined based on an error free channel, so the slave BLE devices frequently perform a connection reestablishing process. Power consumption for performing the connection reestablishing process is significantly large, so total system performance is degraded if a connection is maintained using a CI for a BLE mode which is based on an error free channel.

So, an embodiment of the present disclosure proposes a scheme for controlling a CI based on channel status, and this will be described below.

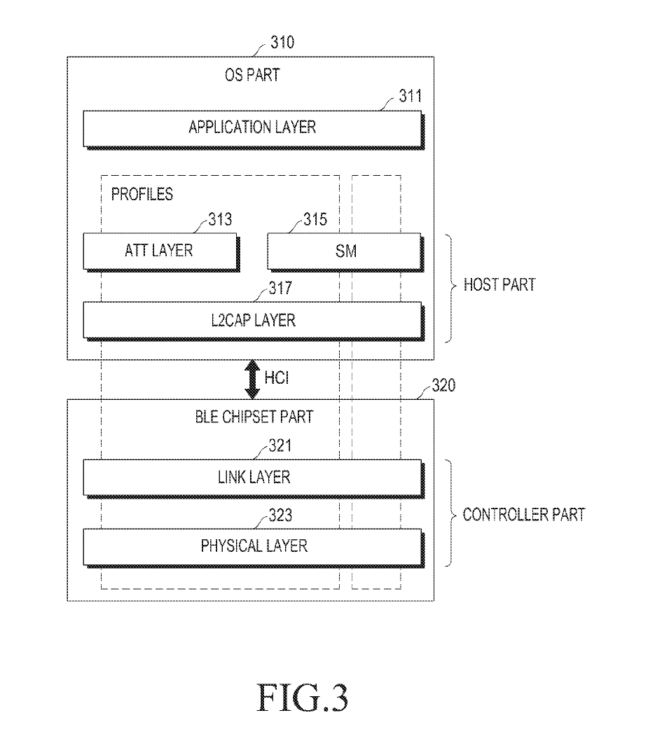

An inner structure of a BLE device in a wireless communication system supporting a Bluetooth scheme according to an embodiment of the present disclosure will be described with reference to FIG. 3.

FIG. 3 schematically illustrates an inner structure of a BLE device in a wireless communication system supporting a Bluetooth scheme according to an embodiment of the present disclosure.

Referring to FIG. 3, a BLE device denotes a device which operates in a BLE mode, and each of a master BLE device and a slave BLE device may be a BLE device.

A BLE device 300 includes an operating system (OS) part 310 and a BLE chipset part 320.

The OS part 310 includes an application layer 311, an attribute protocol (ATT) layer 313, a security manager (SM) 315, and a logical link control and adaptation protocol (L2CAP) layer 317. The ATT layer 313, the SM 315, and the L2CAP layer 317 are included in a host part, and the L2CAP layer 317 may control a CI. This will be described below, so a detailed description will be omitted herein. A detailed description of each of the ATT layer 313 and the SM 315 will be omitted herein.

The BLE chipset part 320 includes a link layer 321 and a physical layer 323. The link layer 321 and the physical layer 323 are included in a controller part, and the link layer 321 may control a CI. This will be described below, so a detailed description will be omitted herein. A detailed description of the physical layer 323 will be omitted herein.

Meanwhile, an interface between the L2CAP layer 317 and the link layer 321 is a host controller interface (HCI).

While the OS part 310 and the BLE chipset part 320 are described in the BLE device 300 as separate units, it is to be understood that this is merely for convenience of description. In other words, the BLE device 300 may be implemented with one processor.

While the application layer 311, the ATT layer 313, the SM 315, and the L2CAP layer 317 are described in the OS part 310 as separate units, it is to be understood that this is merely for convenience of description. In other words, two or more of the application layer 311, the ATT layer 313, the SM 315, and the L2CAP layer 317 may be incorporated into a single unit. The OS part 310 may be implemented with one processor.

While the link layer 321 and the physical layer 323 are described in BLE chipset part 320 as separate units, it is to be understood that this is merely for convenience of description. In other words, the BLE chipset part 320 may be implemented with one processor.

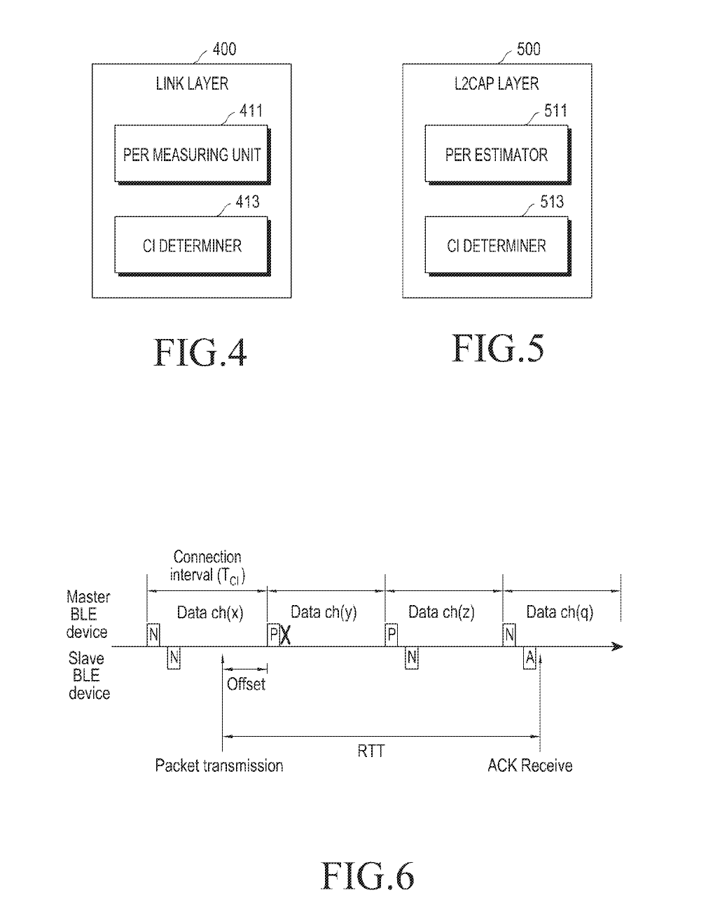

An inner structure of a BLE device in a wireless communication system supporting a Bluetooth scheme according to an embodiment of the present disclosure has been described with reference to FIG. 3, and an inner structure of a link layer in a wireless communication system supporting a Bluetooth scheme according to an embodiment of the present disclosure will be described with reference to FIG. 4.

FIG. 4 schematically illustrates an inner structure of a link layer in a wireless communication system supporting a Bluetooth scheme according to an embodiment of the present disclosure.

Referring to FIG. 4, a link layer 400 includes a PER measuring unit 411 and a CI determiner 413. The link layer 400 is included in a controller part included in a BLE device.

The PER measuring unit 411 may detect the number of data packets which are actually transmitted in a Bluetooth chipset and the number of data packets for which acknowledgements (ACKs) will be received. So, the PER measuring unit 411 measures a PER of a current channel based on the number of data packets which are actually transmitted in the Bluetooth chipset and the number of data packets for which the ACKs will be received, and outputs the measured PER to the CI determiner 413.

The CI determiner 413 determines a CI for decreasing average power consumption of a related BLE device in a current channel corresponding to a preset scheme for determining a CI based on the PER output from the PER measuring unit 411. For example, the CI determiner 413 may determine a CI for minimizing average power consumption of a related BLE device in a current channel corresponding to a preset scheme for determining a CI based on the PER output from the PER measuring unit 411. The scheme for determining the CI will be described below, so a detailed description will be omitted herein.

While the PER measuring unit 411 and the CI determiner 413 are described in the link layer 400 as separate units, it is to be understood that this is merely for convenience of description. In other words, the link layer 400 may be implemented with one processor.

In FIG. 4, the PER measuring unit 411 and the CI determiner 413 are included in the link layer 400, however, it will be understood by those of ordinary skill in the art that the measuring unit 411 and the CI determiner 413 may be located at any part of a controller part included in the BLE device.

In a wireless communication system supporting a Bluetooth scheme according to an embodiment of the present disclosure, channel status is determined based on a PER, so the CI determiner 413 determines a CI based on a measured PER in FIG. 4, however, it will be understood by those of ordinary skill in the art that any parameter which may indicate channel status as well as the PER may be used for determining a CI.

An inner structure of a link layer in a wireless communication system supporting a Bluetooth scheme according to an embodiment of the present disclosure has been described with reference to FIG. 4, and an inner structure of an L2CAP layer in a wireless communication system supporting a Bluetooth scheme according to an embodiment of the present disclosure will be described with reference to FIG. 5.

FIG. 5 schematically illustrates an inner structure of an L2CAP layer in a wireless communication system supporting a Bluetooth scheme according to an embodiment of the present disclosure.

Referring to FIG. 5, an L2CAP layer 500 includes a PER estimator 511 and a CI determiner 513. The L2CAP layer 500 is included in a host part included in a BLE device.

Meanwhile, a controller part included in the BLE device does not inform information related to a retransmitting operation for a data packet which is performed in a link layer included in the controller part to the host part. So, the PER estimator 511 estimates a PER of a channel based on round trip time (RTT) of a data packet which may be estimated in the host part.

The PER estimator 511 outputs the estimated PER to the CI determiner 513.

The CI determiner 513 determines a CI for decreasing average power consumption of a related BLE device in a current channel corresponding to a preset scheme for determining a CI based on the PER output from the PER estimator 511. For example, the CI determiner 513 may determine a CI for minimizing average power consumption of the related BLE device in the current channel corresponding to the preset scheme for determining the CI based on the PER output from the PER estimator 511. The scheme for determining the CI will be described below, so a detailed description will be omitted herein.

While the PER estimator 511 and the CI determiner 513 are described in the L2CAP layer 500 as separate units, it is to be understood that this is merely for convenience of description. In other words, the L2CAP layer 500 may be implemented with one processor.

In FIG. 5, the PER estimator 511 and the CI determiner 513 are included in the L2CAP layer 500, however, it will be understood by those of ordinary skill in the art that the PER estimator 511 and the CI determiner 513 may be located at any part of a host part included in the BLE device.

In a wireless communication system supporting a Bluetooth scheme according to an embodiment of the present disclosure, channel status is determined based on a PER, so the CI determiner 513 determines a CI based on an estimated PER in FIG. 5, however, it will be understood by those of ordinary skill in the art that any parameter which may indicate channel status as well as the PER may be used for determining a CI.

An inner structure of an L2CAP layer in a wireless communication system supporting a Bluetooth scheme according to an embodiment of the present disclosure has been described with reference to FIG. 5, and a scheme for determining a CI in a wireless communication system supporting a Bluetooth scheme according to an embodiment of the present disclosure will be described below.

Firstly, it will be assumed that power which is consumed for null packet transmission is P_{Null}, and power which is consumed for reestablishing a connection, i.e., power which is consumed for a connection reestablishing process is P_{Re-conn}.

In this case, a CI T_{CI} should be appropriately determined for decreasing power P(T_{CI}) which is consumed during the CI T_{CI}, and an optimization issue for minimizing the power P(T_{CI}) may be expressed as Equation (1).

$$\begin{matrix}{min}_{{T}_{CI}} P ( {T}_{CI} ) = {min}_{{T}_{CI}} \{ {P}_{Null} ( {T}_{CI} ) + {P}_{Re \text{-} conn} ( {T}_{CI} ) \} \\ = {min}_{{T}_{CI}} \{ \frac{{E}_{Null}}{{T}_{CI}} + \frac{{E}_{Re \text{-} conn}}{{ST}_{avg} ( {T}_{CI} )} \}\end{matrix} \qquad Equation ( 1 )$$

In Equation (1), each of the P_{Null} and the P_{Re-conn} may be expressed as a function of a CI, and it will be understood that the P_{Null} is decreased if a CI is increased, and the P_{Re-conn} is increased if the CI is increased.

In Equation (1), E_{Null} denotes energy which is consumed for transmitting one null packet or receiving one null packet, and E_{Re-conn} denotes energy which is consumed for reestablishing a connection, i.e., energy which is consumed for a connection reestablishing process. Each of the E_{Null} and the E_{Re-conn} may be a constant value according to a system situation in a wireless communication system supporting a Bluetooth scheme.

In Equation (1), ST_{avg} denotes an average supervision timeout period. The ST_{avg} may be expressed as a function of a CI. The smaller the CI is, the more frequently a null packet is transmitted. In this case, a probability that supervision timeout occurs may be decreased, so ST_{avg} may be decreased. So, if the CI is decreased, P_{re-conn} may be decreased.

In Equation (1), The CIₘᵢₙ≦T_{CI}≦CIₘₐₓ. The CIₘᵢₙ denotes a minimum value of a CI requested for packet delivery performance, e.g., latency and throughput requested by an application which uses a BLE mode, and the CIₘₐₓ denotes a maximum value of the CI requested for the packet delivery performance which is requested by the application which uses the BLE mode.

As described above, a scheme for determining a CI in a wireless communication system supporting a Bluetooth scheme according to an embodiment of the present disclosure may be used in each of a CI determiner 413 in FIG. 4 and a CI determiner 513 in FIG. 5.

A scheme for determining a CI in a wireless communication system supporting a Bluetooth scheme according to an embodiment of the present disclosure has been described above, and a process for estimating a PER in a wireless communication system supporting a Bluetooth scheme according to an embodiment of the present disclosure will be described with reference to FIG. 6.

FIG. 6 schematically illustrates a process for estimating a PER in a wireless communication system supporting a Bluetooth scheme according to an embodiment of the present disclosure.

Referring to FIG. 6, as described in FIG. 5, a controller part included in a BLE device does not inform information related to a retransmitting operation for a data packet which is performed in a link layer included in the controller part to a host part included in the BLE device. So, a PER estimator included in the host part estimates a PER of a channel based on RTT of a data packet which may be estimated in the host part.

A minimum value of RTT may be expressed as Equation (2).

RTTₘᵢₙ=offset+T_{CI} Equation (2)

In Equation (2), offset denotes time from a timing point at which a packet occurs to a timing point at which an actual data packet is transmitted.

Further, RTT in a case that retransmission for a related data packet occurs one time may be expressed as Equation (3).

RTT=offset+2*T_{CI}=RTTₘᵢₙ+1*T_{CI} Equation (3)

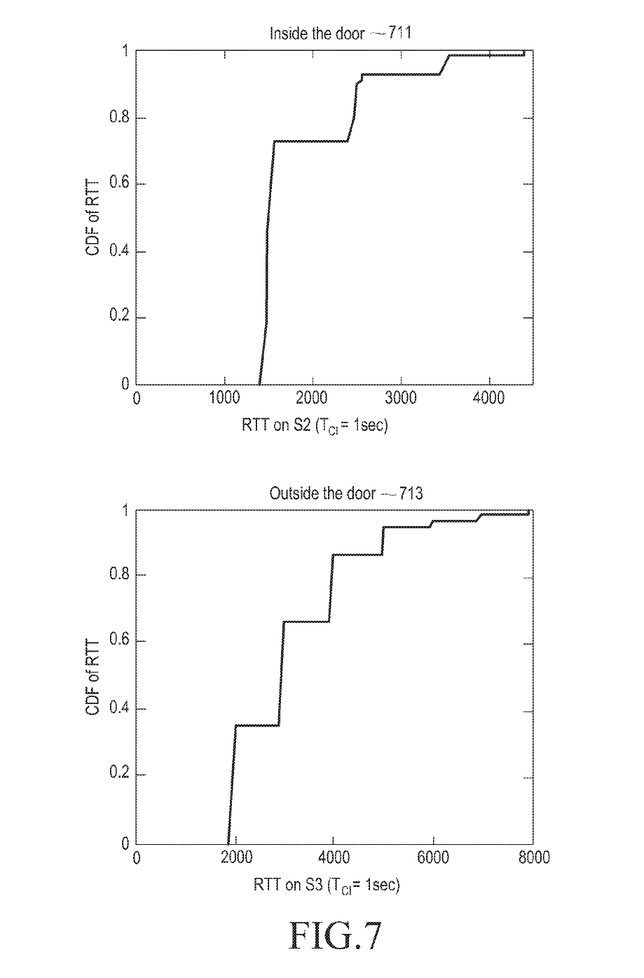

A process for estimating a PER in a wireless communication system supporting a Bluetooth scheme according to an embodiment of the present disclosure has been described with reference to FIG. 6, and relation between a retransmission count for a data packet and RTT for the data packet in a wireless communication system supporting a Bluetooth scheme according to an embodiment of the present disclosure will be described with reference to FIG. 7.

FIG. 7 schematically illustrates relation between a retransmission count for a data packet and RTT for the data packet in a wireless communication system supporting a Bluetooth scheme according to an embodiment of the present disclosure.

Referring to FIG. 7, the more increased a retransmission count for a data packet is, the more increased RTT for the data packet is.

An RTT graph 711 in the inside of a door, e.g., in a slave BLE device 2 as described in FIG. 2 and an RTT graph 713 in the outside of the door, e.g., in a slave BLE device 3 as described in FIG. 2 are illustrated in FIG. 7. A vertical axis in each of graphs in FIG. 7 indicates a cumulative density function (CDF) of RTT, and a horizontal axis denotes RTT at a related location. It will be noted that the RTT graphs 711 and 713 are RTT graphs of a related BLE device in a case that T_{CI} is 1 second (T_{CI}=1 sec).

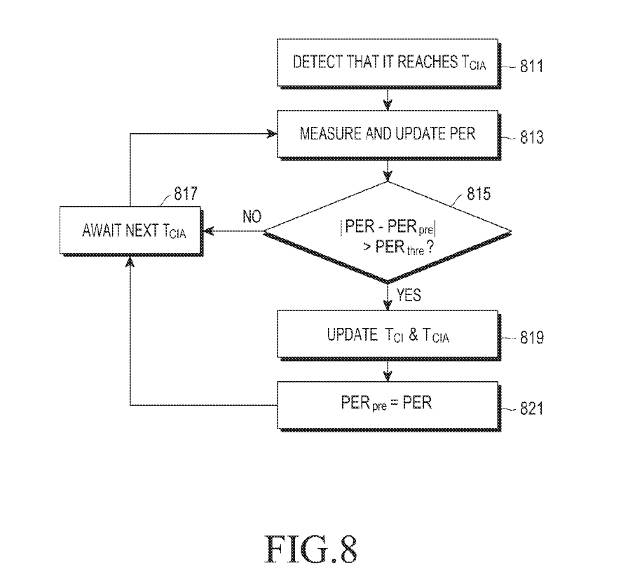

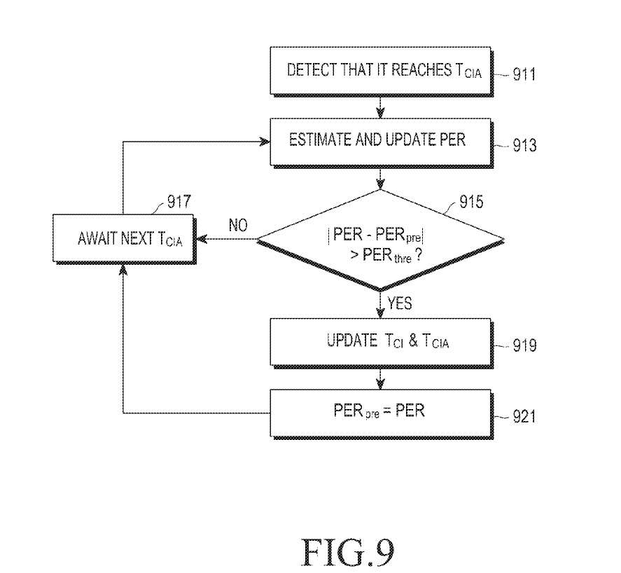

Relation between a retransmission count for a data packet and RTT for the data packet in a wireless communication system supporting a Bluetooth scheme according to an embodiment of the present disclosure has been described with reference to FIG. 7, and a process for controlling a CI in a wireless communication system supporting a Bluetooth scheme according to an embodiment of the present disclosure will be described with reference to FIGS. 8 and 9.

FIG. 8 schematically illustrates an example of a process for controlling a CI in a wireless communication system supporting a Bluetooth scheme according to an embodiment of the present disclosure.

Referring to FIG. 8, it will be assumed that a process for controlling a CI in FIG. 8 is a process controlling a CI which is performed in a link layer included in a controller part of a BLE device.

A link layer detects that it reaches a CI updating interval T_{CIA} as an interval during which a CI T_{CI} should be updated at operation 811. Here, a CIA scheme denotes a CI adaptation scheme, and denotes a scheme for updating a CI by updating a PER which indicates channel status. The CI T_{CI} may be maintained or updated every T_{CIA}.

The link layer measures a PER based on the number of data packets which are actually transmitted in a Bluetooth chipset and the number of data packets for which ACKs will be received to update the PER at operation 813. A scheme for measuring the PER to update the PER has been described above, so a detailed description will be omitted herein. The link layer determines whether difference |PER−PER_{Pre}| between a PER which is measured in a current T_{CIA} and a PER which is measured in a previous T_{CIA} is greater than a threshold PER PERₜₕᵣₑ at operation 815. If the |PER−PER_{Pre}| is not greater than the PERₜₕᵣₑ, that is, if the |PER−PER_{Pre}| is equal to or less than the PERₜₕᵣₑ, the link layer awaits the next CI updating interval at operation 817, and proceeds to operation 813.

If the |PER−PER_{Pre}| is greater than the PERₜₕᵣₑ, the link layer updates a CI T_{CI} and a CI updating interval T_{CIA} at operation 819. A scheme for updating the CI T_{CI} has been described above, so a detailed description will be omitted herein. The link layer sets the updated PER to a previous PER PERₚᵣₑ at operation 821, and proceeds to operation 817.

Although FIG. 8 illustrates an example of a process for controlling a CI in a wireless communication system supporting a Bluetooth scheme according to an embodiment of the present disclosure, various changes could be made to FIG. 8. For example, although shown as a series of operations, various operations in FIG. 8 could overlap, occur in parallel, occur in a different order, or occur multiple times.

An example of a process for controlling a CI in a wireless communication system supporting a Bluetooth scheme according to an embodiment of the present disclosure has been described with reference to FIG. 8, and another example of a process for controlling a CI in a wireless communication system supporting a Bluetooth scheme according to an embodiment of the present disclosure will be described with reference to FIG. 9.

FIG. 9 schematically illustrates another example of a process for controlling a CI in a wireless communication system supporting a Bluetooth scheme according to an embodiment of the present disclosure.

Referring to FIG. 9, it will be assumed that a process for controlling a CI in FIG. 9 is a process controlling a CI which is performed in an L2CAP layer included in a host part of a BLE device.

An L2CAP layer detects that it reaches a CI updating interval T_{CIA} as an interval during which a CI T_{CI} should be updated at operation 911. The L2CAP layer estimates a PER of a channel based on RTT of a data packet which may be measured in the host part to update the PER at operation 913. A scheme for estimating the PER to update the PER has been described above, so a detailed description will be omitted herein. The L2CAP layer determines whether difference |PER−PER_{Pre}| between a PER which is estimated in a current T_{CIA} and a PER which is estimated in a previous T_{CIA} is greater than a threshold PER PERₜₕᵣₑ at operation 915. If the |PER−PER_{Pre}| is not greater than the PERₜₕᵣₑ, that is, if the |PER−PER_{Pre}| is equal to or less than the PERₜₕᵣₑ, the L2CAP layer awaits the next CI updating interval at operation 917, and proceeds to operation 913.

If the |PER−PER_{Pre}| is greater than the PERₜₕᵣₑ, the L2CAP layer updates a CI T_{CI} and a CI updating interval T_{CIA} at operation 919. A scheme for updating the CI T_{CI} has been described above, so a detailed description will be omitted herein. The L2CAP layer sets the updated PER to a previous PER PERₚᵣₑ at operation 921, and proceeds to operation 917.

Although FIG. 9 illustrates another example of a process for controlling a CI in a wireless communication system supporting a Bluetooth scheme according to an embodiment of the present disclosure, various changes could be made to FIG. 9. For example, although shown as a series of operations, various operations in FIG. 9 could overlap, occur in parallel, occur in a different order, or occur multiple times.

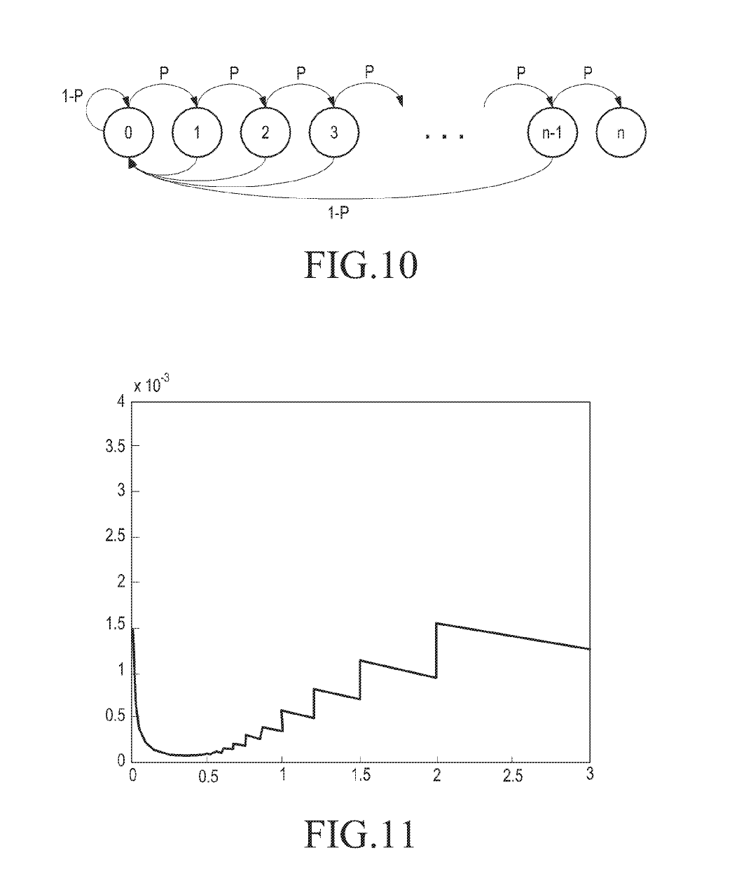

Another example of a process for controlling a CI in a wireless communication system supporting a Bluetooth scheme according to an embodiment of the present disclosure has been described with reference to FIG. 9, and a scheme for detecting an average supervision timeout period according to a CI in a wireless communication system supporting a Bluetooth scheme according to an embodiment of the present disclosure will be described with reference to FIG. 10.

FIG. 10 schematically illustrates a scheme for detecting an average supervision timeout period according to a CI in a wireless communication system supporting a Bluetooth scheme according to an embodiment of the present disclosure.

Referring to FIG. 10, ST_{avg}(T_{CI}) denotes an average supervision timeout period for a CI T_{CI}, and denotes the average number of state transitions until supervision timeout according to the CI T_{CI} occurs.

Further, P denotes a PER, and n denotes the number of packet errors due to supervision timeout. Here,

$$n = ⌊ \frac{{T}_{ST}}{{T}_{CI}} ⌋ .$$

A scheme for detecting the ST_{avg}(T_{CI}) will be described below.

Firstly, in a state diagram in FIG. 10, n denotes a null packet transmission count which may be tried until a supervision timeout occurs, and an index of each state denotes a count of null packet transmissions which are successively failed. That is, it reaches a state n when null packet transmission fails consecutively n times. In this case, supervision timeout occurs. Here, the ST_{avg}(T_{CI}) becomes state transition count which should be averagely passed until it reaches a state n from a state 0*CI.

However, there are many cases that it may reach a state n from a state 0, so a state transition count which should be averagely passed until it reaches the state n from the state 0 may become significantly increased.

So, in an embodiment of the present disclosure, a CI determiner may calculate ST_{avg}(T_{CI}) as expressed in Equation (4).

$${ST}_{avg} ( {T}_{CI} ) = {\sum }_{k = 0}^{∞} ( {T}_{F} + {kT}_{S} ) {p}_{F} {p}_{S}^{k} = {T}_{F} + {T}_{S} \frac{P}{( 1 - {P}_{S} )} \qquad Equation ( 4 )$$

In Equation (4), p_{F}, P_{S}, T_{F}, and T_{S} may be expressed as Equation (5).

$${p}_{F} = {P}^{n} , {p}_{S} = 1 - {P}^{n} \\ {T}_{F} = {T}_{ST} , {T}_{S} = \frac{{T}_{CI} \{ 1 - ( n + 1 ) {P}^{n} + {nP}^{n + 1} \}}{( 1 - {P}^{n} ) ( 1 - P )} \qquad Equation ( 5 )$$

In Equation (4) and Equation (5), a case S indicates a case that packet transmission by a BLE device is successful before supervision timeout occurs, and a case F indicates a case that packet transmission by the BLE device is failed before the supervision timeout occurs. That is, the case S denotes a case that it starts from a state 0 before supervision timeout occurs, and succeeds in null packet transmission before it reaches a state n to return to the state 0, and the case F denotes a case that it starts from the state 0 before the supervision timeout occurs and reaches the state n.

So, the CI determiner calculates average time which is consumed in each of a case that the case S occurs and a case that the case F occurs, and a probability that each of the case S and the case F occurs, and calculates time which is averagely consumed until supervision timeout occurs based on the average time which is consumed in each of the case that the case S occurs and the case that the case F occurs, and the probability that each of the case S and the case F occurs.

That is, the case S may be one of various cases including a case that it starts from a state 0 and succeeds in the first null packet transmission to return to the state 0, a case that it starts from the state 0, fails in up to n−1 null packet transmissions, and succeeds in the last null packet transmission to return to the state 0, and the like. So, the CI determiner multiplies time which is consumed in a case that each case occurs and a probability that each case occurs in order to calculate time which is averagely consumed in a case that the case S occurs, and sums the multiplied values to calculate average time which is consumed in the case S, and the average time which is consumed in the case S may be expressed as Equation (6).

$${T}_{S} = {\sum }_{k = 1}^{n} ( k * {T}_{CI} ) * \frac{{P}^{k - 1} * ( 1 - P )}{{P}_{S}} = \frac{{T}_{CI} * ( 1 - P )}{{P}_{S}} * {\sum }_{k = 1}^{n} ( k * {P}^{k - 1} ) \qquad Equation ( 6 )$$

Further, average time which is consumed in a case S as expressed in Equation (6) may be expressed as Equation (8) using definition in Equation (7).

$$\begin{matrix} X = {\sum }_{k = 1}^{n} ( k * {P}^{k - 1} ) = 1 + 2 P + 3 {P}^{2} + ⋯ + {nP}^{n - 1} \\ PX = P + 2 {P}^{2} + 3 {P}^{3} + ⋯ + {nP}^{n} \\ ( 1 - P ) X = 1 + P + {P}^{2} + ⋯ + {P}^{n - 1} - {nP}^{n} = \frac{1 - {P}^{n}}{1 - P} - {nP}^{n} \\ X = \frac{1 - ( N + 1 ) {P}^{n} + {nP}^{n + 1}}{{( 1 - P )}^{2}} & Equation ( 7 ) \\ {T}_{S} = \frac{{T}_{CI} * ( 1 - P )}{{P}_{S}} * \frac{1 - ( n + 1 ) {P}^{n} + {nP}^{n + 1}}{{( 1 - P )}^{2}} = \frac{{T}_{CI} \{ 1 - ( n + 1 ) {P}^{n} + {nP}^{n + 1} \}}{( 1 - {P}^{n} ) ( 1 - P )} & Equation ( 8 )\end{matrix}$$

As a result, power which is averagely consumed for maintaining a connection according to a T_{CI} in a LE device may be expressed as Equation (9).

$$Equation ( 9 )$$

$$\begin{matrix}P ( {T}_{CI} ) = \frac{{E}_{null}}{{T}_{CI}} + \frac{{E}_{re \text{-} conn}}{{ST}_{avg} ( {T}_{CI} )} \\ = \frac{{E}_{null}}{{T}_{CI}} + \frac{{E}_{re \text{-} conn}}{{T}_{ST} + \frac{{T}_{CI} \{ 1 - ( n + 1 ) {P}^{n} + {nP}^{n + 1} \}}{( 1 - P ) {P}^{n}}} \\ = \frac{{E}_{null}}{{T}_{CI}} + \frac{{E}_{re \text{-} conn}}{{T}_{ST} + \frac{{T}_{CI} \{ 1 - ( ⌊ \frac{{T}_{ST}}{{T}_{CI}} ⌋ + 1 ) {P}^{⌊ \frac{{T}_{ST}}{{T}_{CI}} ⌋} + ⌊ \frac{{T}_{ST}}{{T}_{CI}} ⌋ {P}^{⌊ \frac{{T}_{ST}}{{T}_{CI}} ⌋ + 1} \}}{( 1 - P ) {P}^{⌊ \frac{{T}_{ST}}{{T}_{CI}} ⌋}}}\end{matrix}$$

In Equation (9), each of Eₙᵤₗₗ, E_{re-conn}, P, and ST may be a given constant value, and T_{CI} may be a variable.

Meanwhile, power which is averagely consumed for maintaining a connection in a BLE device according to a CI TCI as expressed in Equation (9) may be expressed as Equation (10).

$$\begin{matrix}P ( {T}_{CI} ) = \frac{{E}_{null}}{{T}_{CI}} + \frac{{E}_{re \text{-} conn}}{{ST}_{avg} ( {T}_{CI} )} \\ = \frac{{E}_{null}}{{T}_{CI}} + \frac{{E}_{re \text{-} conn}}{{T}_{ST} + \frac{{T}_{CI} \{ 1 - ( n + 1 ) {P}^{n} + {nP}^{n + 1} \}}{( 1 - P ) {P}^{n}}}\end{matrix} \qquad Equation ( 10 )$$

In Equation (10),

$$n = ⌊ \frac{{T}_{ST}}{{T}_{CI}} ⌋ .$$

If power P(T_{CI}) which is averagely consumed for maintaining a connection according to a CI T_{CI} as expressed in Equation (10) in a BLE device is expressed in a form of graph, the power P(T_{CI}) may be illustrated as FIG. 11.

FIG. 11 schematically illustrates power which is averagely consumed for maintaining a connection according to a CI in a BLE device in a wireless communication system supporting a Bluetooth scheme according to an embodiment of the present disclosure.

Referring to FIG. 11, it will be noted that a graph indicating power which is averagely consumed for maintaining a connection according to a CI in a BLE device in FIG. 11 is a graph which is generated based on power P(T_{CI}) which is averagely consumed for maintaining a connection according to a CI T_{CI} as expressed in Equation (10) in a BLE device. In FIG. 11, a vertical axis indicates power P(T_{CI}), and a horizontal axis indicates a CI T_{CI}.

The graph in FIG. 11 has a stair form, i.e., a non-convex form due to

$$n = ⌊ \frac{{T}_{ST}}{{T}_{CI}} ⌋$$

as expressed in Equation (10).

So, due to the non-convex form, a BLE device may detect an optimal T_{CI} in a case that all possible T_{CI} values, i.e., all values which are multiples of 1.25 milliseconds, and are from 7.5 milliseconds to ST/2 are substituted in Equation (10). This may be expressed as Equation (11).

$$\{ {T}_{CI} \vert {T}_{CI} = \frac{{T}_{ST}}{n} where n is positive integer and ⌊ \frac{{T}_{ST}}{{CI}_{max}} ⌋ ≦ n ≦ ⌊ \frac{{T}_{ST}}{{CI}_{min}} ⌋ \} . \qquad Equation ( 11 )$$

An optimal value of the CI T_{CI} is determined as T_{CI} included in a set as expressed in Equation (11), and should be determined thereby minimizing P(T_{CI}). This will be proved below.

Firstly, in T_{CI} which satisfies a criterion

$$\frac{{T}_{ST}}{n + 1} < {T}_{CI} ≦ \frac{{T}_{ST}}{n} , ⌊ \frac{{T}_{ST}}{{T}_{CI}} ⌋$$

is n.

Meanwhile, a CI T_{CI} which uses a fixed value n and a monotone decreasing function according to P may be expressed as Equation (12).

$$P ( {T}_{CI} ) = \frac{{E}_{null}}{{T}_{CI}} + \frac{{E}_{re \text{-} conn}}{ST + \frac{{T}_{CI} \{ 1 - ( n + 1 ) {P}^{n} + {nP}^{n + 1} \}}{( 1 - P ) {P}^{n}}} \qquad Equation ( 12 )$$

So, the optimal value of the CI T_{CI} is

$$\frac{{T}_{ST}}{n}$$

within a range

$$\frac{{T}_{ST}}{n + 1} < {T}_{CI} ≦ \frac{{T}_{ST}}{n} .$$

Meanwhile, an embodiment of the present disclosure may relax n which should have an integer to a real number. That is, an embodiment of the present disclosure may relax n to a real number from an integer.

$$n = ⌊ \frac{{T}_{ST}}{{T}_{CI}} ⌋ = \frac{{T}_{ST}}{{T}_{CI}} \qquad Equation ( 13 )$$

After n is relaxed to a real number from an integer, P may be expressed as a function of n, and may be expressed as Equation (14).

$${min}_{n} P ( n ) = \frac{{E}_{null}}{{T}_{ST}} n + \frac{{E}_{re \text{-} conn}}{{T}_{ST}} * \frac{n ( 1 - p ) {p}^{n}}{1 - {p}^{n}} \qquad Equation ( 14 )$$

As expressed in Equation (14), it will be understood that P has a convex form for n.

Meanwhile, if P(n) as expressed in Equation (14) is differentiated for n two times, this may be expressed as Equation (15).

$${P}^{″} ( n ) = \frac{{E}_{re - conn}}{{T}_{ST}} \frac{( 1 - P ) {P}^{n} \{ 2 ln P + {n ( ln P )}^{2} - 2 ln {PP}^{n} + {n ( ln P )}^{2} {P}^{n} \} }{{( 1 - {P}^{n} )}^{3}} \qquad Equation ( 15 )$$

As expressed in Equation (15), if P(n) as expressed in Equation (14) is differentiated for n two times, it will be understood that a second derivative of P(n), i.e., a value of P″(n) is always greater than 0.

So, a scheme for detecting an optimal TCI based on a result as expressed in Equation (15) will be described below.

Firstly, a BLE device detects an optimal value of n.

The BLE device may relatively easily detect an optimal value of n using the fact that P(n) is a convex function. That is, the BLE device may detect the optimal value of n by increasing n by 1 from a starting point

$$⌊ \frac{{T}_{ST}}{{CI}_{max}} ⌋$$

until P(n+1) is greater than P(n).

So, if P(n+1) is greater than P(n), that is, if P(n+1)>P(n), a value of n at a related timing point becomes an optimal value of n.

Secondly, the BLE device may detect an optimal value of a CI T_{CI}, and this may be expressed as Equation (16).

$${T}_{{CI}_{opt}} = \frac{{T}_{ST}}{{n}_{opt}} \qquad Equation ( 16 )$$

Meanwhile, constraint for the CI T_{CI} is that the CI T_{CI} should be multiples of 1.25 milliseconds.

If

$$\frac{{T}_{ST}}{{n}_{opt}}$$

is not multiples of 1.25 milliseconds, the BLE device may select an optimal value of the CI T_{CI} as expressed in Equation (17).

$${T}_{{CI}_{opt}} = 1.25 m sec * ⌊ \frac{{T}_{ST} / {n}_{opt}}{1.25 m sec} ⌋ \qquad Equation ( 17 )$$

Complexity of each of a scheme for detecting an optimal value of a CI T_{CI} after calculating power consumption using all possible values for the CI T_{CI} and a scheme for detecting an optimal value of a CI T_{CI} after relaxing a value of n to a real number from an integer will be described below.

Firstly, the scheme for detecting the optimal value of the CI T_{CI} after calculating the power consumption using all possible values for the CI T_{CI} may be expressed as Equation (18).

T_{CI}=1.25 msec*n Equation (18)

In Equation (18), all values of n as expressed in

$$\frac{{CI}_{min}}{1.23 m sec} ≦ n ≦ \frac{{CI}_{max}}{1.25 m sec}$$

are considered for a CI T_{CI}. So, as expressed in Equation (18), complexity of the scheme for detecting the optimal value of the CI T_{CI} after calculating the power consumption using all possible values for the CI T_{CI} is linearly increased according to a maximum CI, i.e., T_{CImax}. That is, in the scheme for detecting the optimal value of the CI T_{CI} after calculating the power consumption using all possible values for the CI T_{CI}, it will be understood that a range of a value of usable CI T_{CI} is linearly increased according to a value of ST.

Secondly, in the scheme for detecting the optimal value of the CI T_{CI} after relaxing the value of n to the real number from the integer, P is a convex function of n. So, in a case that a value of P(n) is calculated while a value of n is sequentially increased from 1 by 1, a value of n at a timing point at which P(n+1) is greater than P(n) at the first time is the optimal value of the CI T_{CI}. Here, n denotes a null packet transmission count which may be tried before supervision timeout occurs.

So, in the scheme for detecting the optimal value of the CI T_{CI} after relaxing the value of n to the real number from the integer, the number of values of n which should be discovered by a BLE device may be significantly decreased. At this time, in a case that a value of └ST/CI┘ is fixed to n, power which is consumed for reestablishing a connection in P(T_{CI}) and power which is consumed for transmitting a null packet is decreased if T_{CI} is increased. So, the BLE device determines a value of T_{CI} which satisfies a criterion └ST/CI┘=n and is maximum as the optimal value of the CI T_{CI}.

Next, performance according to a scheme for controlling a CI in a wireless communication system supporting a Bluetooth scheme according to an embodiment of the present disclosure will be described below.

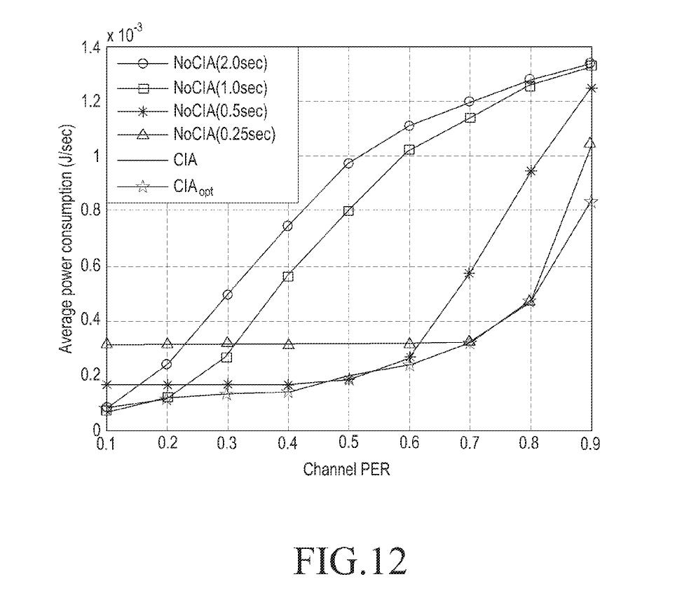

An example of a simulation result according to a scheme for controlling a CI in a wireless communication system supporting a Bluetooth scheme according to an embodiment of the present disclosure will be described with reference to FIG. 12.

FIG. 12 schematically illustrates an example of a simulation result according to a scheme for controlling a CI in a wireless communication system supporting a Bluetooth scheme according to an embodiment of the present disclosure.

Referring to FIG. 12, it will be noted that a simulation result according to a scheme for controlling a CI according to an embodiment of the present disclosure is a simulation result in a case that it will be assumed that all BLE channels have the same PER and the PER is not changed.

In FIG. 12, a vertical axis denotes average power consumption, and a horizontal axis denotes a channel PER. Further, it will be noted that a simulation result in FIG. 12 is a simulation result in a case that simulation time is one hour, and T_{ST} is 6 seconds (T_{ST}=6 sec).

In FIG. 12, it will be noted that a simulation result in a case that a scheme for controlling a CI according to an embodiment of the present disclosure is not used is illustrated as NoCIA, and a simulation result in a case that the scheme for controlling the CI according to an embodiment of the present disclosure is used is illustrated as CIA. Here, a CI TCI which is used in a case that the scheme for controlling the CI according to an embodiment of the present disclosure is not used is separately marked in parenthesis. For example, a simulation result in a case that a CI TCI is 2 seconds and the scheme for controlling the CI according to an embodiment of the present disclosure is not used is illustrated as NoCIA (2.0 sec).

For convenience, a scheme in which a scheme for controlling a CI according to an embodiment of the present disclosure, that is, a conventional scheme in which a fixed CI T_{CI} is used will be referred to as a NoCIA scheme. In the NoCIA scheme, a CI T_{CI} which achieves minimum power consumption according to a PER is used as a fixed CI T_{CI}.

For convenience, a scheme for controlling a CI according to an embodiment of the present disclosure will be referred to as a CIA scheme. Further, a scheme for controlling a CI T_{CI} thereby optimizing power P(T_{CI}) which is consumed during a CI T_{CI}, that is, a scheme for controlling a CI T_{CI} thereby minimizing power P(T_{CI}) which is consumed during a CI T_{CI}, according to an embodiment of the present disclosure will be referred to as a CIAₒₚₜ scheme.

In the CIA scheme, a CI TCI is adaptively updated thereby minimum power consumption is guaranteed at all PERs.

As illustrated in FIG. 12, it will be understood that a CI T_{CI} is changed in each of a NoCIA scheme, a CIA scheme, and a CIAₒₚₜ scheme according to change in a PER of a channel. However, it will be understood that power consumption according to a CIAₒₚₜ scheme according to an embodiment of the present disclosure is minimized at all PERs.

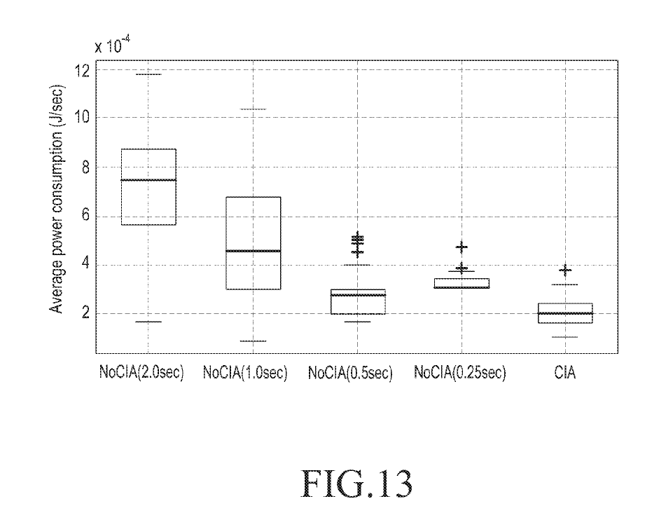

An example of a simulation result according to a scheme for controlling a CI in a wireless communication system supporting a Bluetooth scheme according to an embodiment of the present disclosure has been described with reference to FIG. 12, and another example of a simulation result according to a scheme for controlling a CI in a wireless communication system supporting a Bluetooth scheme according to an embodiment of the present disclosure will be described with reference to FIG. 13.

FIG. 13 schematically illustrates another example of a simulation result according to a scheme for controlling a CI in a wireless communication system supporting a Bluetooth scheme according to an embodiment of the present disclosure.

Referring to FIG. 13, it will be noted that a simulation result according to a scheme for controlling a CI according to an embodiment of the present disclosure in FIG. 13 is a simulation result in a case that it will be assumed that trace is changed every preset time, e.g., every five minutes, that is, in a case that it will be assumed that a channel environment is changed according to time.

In FIG. 13, a vertical axis indicates average power consumption and a horizontal axis indicates each scheme. Further, it will be noted that a simulation result in FIG. 13 indicates a simulation result in a case that simulation time is one hour, and T_{ST} is 6 seconds (T_{ST}=6 sec).

In FIG. 13, it will be noted that a simulation result in a case that a scheme for controlling a CI according to an embodiment of the present disclosure is not used is illustrated as NoCIA, and a simulation result in a case that the scheme for controlling the CI according to an embodiment of the present disclosure is used is illustrated as CIA. Here, a CI T_{CI} which is used in a case that the scheme for controlling the CI according to an embodiment of the present disclosure is not used is separately marked in parenthesis. For example, a simulation result in a case that a CI T_{CI} is 2 seconds and the scheme for controlling the CI according to an embodiment of the present disclosure is not used is illustrated as NoCIA (2.0 sec).

As illustrated in FIG. 13, in a NoCIA scheme, if a lengthy CI T_{CI} is used, a connection is frequently released, so energy which is consumed for reestablishing a connection may be great. Further, in the NoCIA scheme, if a CI T_{CI} which is too short is used, a null packet is frequently transmitted, so energy which is consumed for transmitting a null packet may be great. As illustrated in FIG. 13, in the NoCIA scheme, it will be understood that power consumption is minimal if a CI T_{CI} is set to 0.5 second. However, even though the CI T_{CI} is set to 0.5 second, a channel situation is continuously changed, so an optimal issue in power consumption may be still not solved.

Meanwhile, in the CIA scheme, a CI TCI is adjusted thereby being appropriate to a channel situation which is changed real time, so power consumption which is less than minimum power consumption in a case that the NoCIA scheme is used may be achieved.

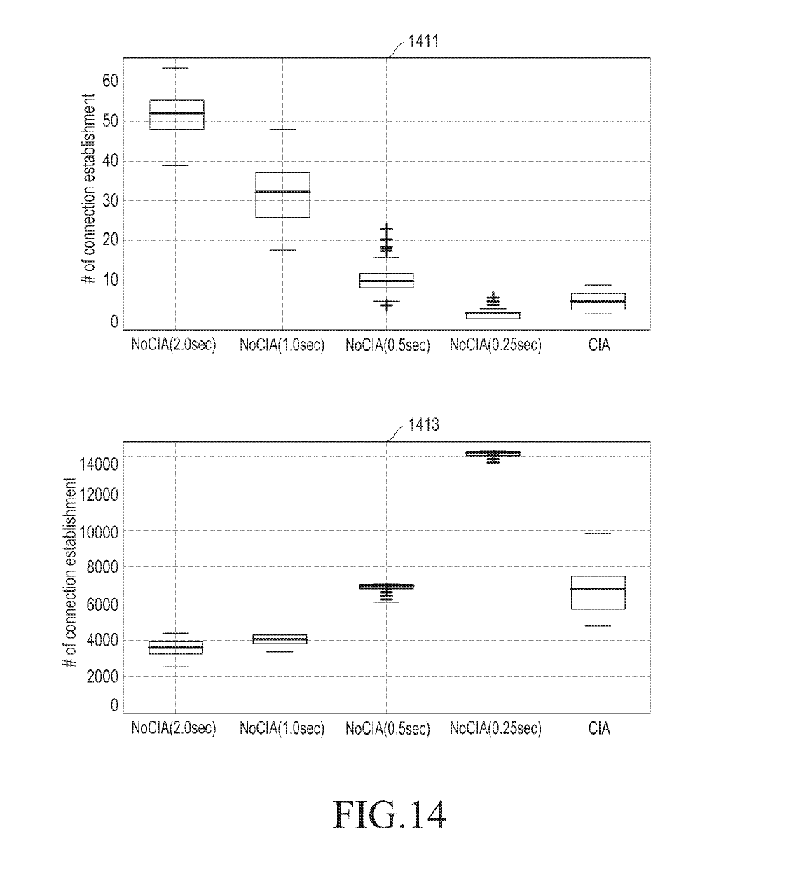

Another example of a simulation result according to a scheme for controlling a CI in a wireless communication system supporting a Bluetooth scheme according to an embodiment of the present disclosure has been described with reference to FIG. 13, and still another example of a simulation result according to a scheme for controlling a CI in a wireless communication system supporting a Bluetooth scheme according to an embodiment of the present disclosure will be described with reference to FIG. 14.

FIG. 14 schematically illustrates still another example of a simulation result according to a scheme for controlling a CI in a wireless communication system supporting a Bluetooth scheme according to an embodiment of the present disclosure.

Referring to FIG. 14, it will be noted that a simulation result according to a scheme for controlling a CI according to an embodiment of the present disclosure in FIG. 14 is a simulation result in a case that it will be assumed that trace is changed every preset time, e.g., every five minutes, that is, in a case that it will be assumed that a channel environment is changed according to time.

In FIG. 14, a vertical axis denotes connection establishment count, and a horizontal axis denotes each scheme. Further, it will be noted that a simulation result in FIG. 14 is a simulation result in a case that simulation time is one hour, and T_{ST} is 6 seconds (T_{ST}=6 sec).

In FIG. 14, it will be noted that a simulation result in a case that a scheme for controlling a CI according to an embodiment of the present disclosure is not used is illustrated as NoCIA, and a simulation result in a case that the scheme for controlling the CI according to an embodiment of the present disclosure is used is illustrated as CIA. Here, a CI T_{CI} which is used in a case that the scheme for controlling the CI according to an embodiment of the present disclosure is not used is separately marked in parenthesis. For example, a simulation result in a case that a CI T_{CI} is 2 seconds and the scheme for controlling the CI according to an embodiment of the present disclosure is not used is illustrated as NoCIA (2.0 sec).

As illustrated in FIG. 14, it will be understood that the number of times a connection is released may be decreased (1411), but the number of times a null packet is transmitted may be increased (1413), if a value of a CI T_{CI} is decreased.

So, in a case that a value of a CI T_{CI} is adjusted based on a CIA scheme according to an embodiment of the present disclosure, the number of times a connection is released may be decreased and the number of times a null packet is transmitted may be increased, so power consumption during the CI T_{CI} may be decreased.

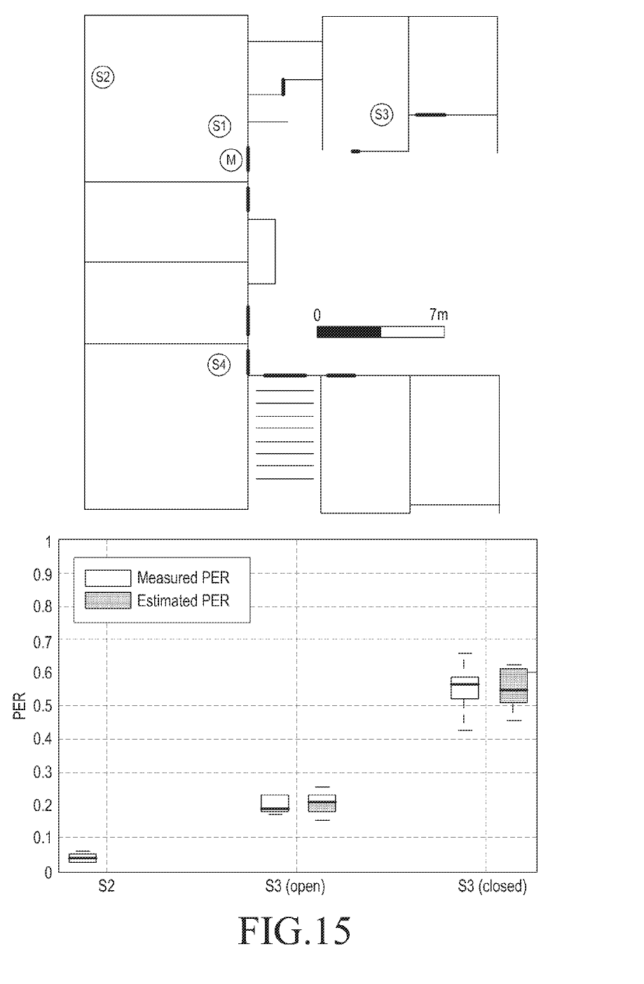

Still another example of a simulation result according to a scheme for controlling a CI in a wireless communication system supporting a Bluetooth scheme according to an embodiment of the present disclosure has been described with reference to FIG. 14, and relation between a measured PER and an estimated PER in a wireless communication system supporting a Bluetooth scheme according to an embodiment of the present disclosure will be described with reference to FIG. 15.

FIG. 15 schematically illustrates relation between a measured PER and an estimated PER in a wireless communication system supporting a Bluetooth scheme according to an embodiment of the present disclosure.

Referring to FIG. 15, it will be noted that a simulation result according to a scheme for controlling a CI according to an embodiment of the present disclosure is a simulation result in a case assuming a smart home network as environment which should support connectivity with a long range. It will be assumed that there are a master BLE device and a plurality of slave BLE devices, e.g., four slave BLE devices, e.g., a slave BLE device 1, a slave BLE device 2, a slave BLE device 3, and a slave BLE device 4 in the smart home network. Here, it will be assumed that location of the master BLE device is fixed. For convenience, it will be noted that the master BLE device is illustrated as “M”, and the slave BLE device 1, the slave BLE device 2, the slave BLE device 3, and the slave BLE device 4 are illustrated as “S1”, “S2”, “S3”, and “S4”, respectively.

If there are a master BLE device, and a slave BLE device 1, a slave BLE device 2, a slave BLE device 3, and a slave BLE device 4 as illustrated in FIG. 15, it will be understood that channel status of the slave BLE device 1 is relatively good, and channel status of each of the slave BLE device 2, the slave BLE device 3, and the slave BLE device 4 is relatively bad. That is, the slave BLE device 1 is very close to the master BLE device, so the channel status of the slave BLE device 1 is relatively good, and each of the slave BLE device 2, the slave BLE device 3, and the slave BLE device 4 is far from the master BLE device, so the channel status of each of the slave BLE device 2, the slave BLE device 3, and the slave BLE device 4 is relatively bad.

Meanwhile, as illustrated in FIG. 15, it will be understood that a PER which is measured in an actual channel situation is almost similar to an estimated PER, i.e., a PER which is estimated based on RTT. So, it will be understood that performance which is almost similar to performance which is acquired in a case that an actual measured PER is used may be acquired even though a PER which is estimated in a CIA scheme and a CIAopt scheme according to an embodiment of the present disclosure is used.

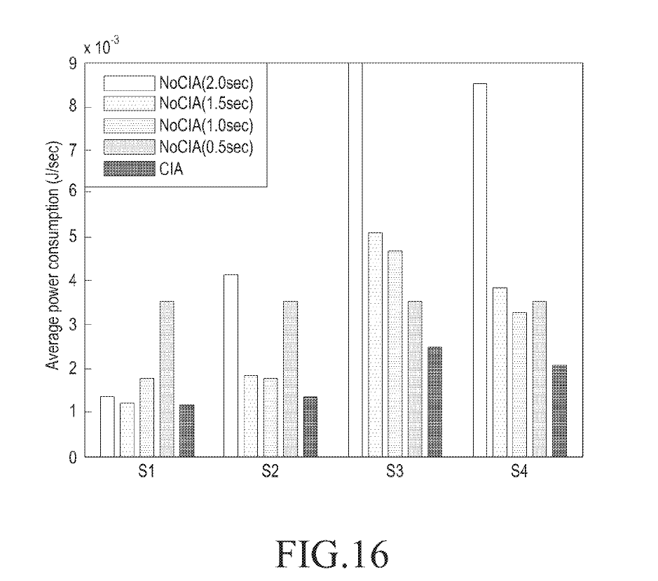

Relation between a measured PER and an estimated PER in a wireless communication system supporting a Bluetooth scheme according to an embodiment of the present disclosure has been described with reference to FIG. 15, and still another example of a simulation result according to a scheme for controlling a CI in a wireless communication system supporting a Bluetooth scheme according to an embodiment of the present disclosure will be described with reference to FIG. 16.

FIG. 16 schematically illustrates still another example of a simulation result according to a scheme for controlling a CI in a wireless communication system supporting a Bluetooth scheme according to an embodiment of the present disclosure.

Referring to FIG. 16, it will be assumed that a simulation result according to a scheme for controlling a CI according to an embodiment of the present disclosure is a simulation result in a case that a smart home network environment is assumed like in FIG. 15.

In FIG. 16, a vertical axis indicates average power consumption and a horizontal axis indicates each slave BLE device. Further, a simulation result in FIG. 16 denotes average power consumption of each slave BLE device during one day.

In FIG. 16, it will be noted that a simulation result in a case that a scheme for controlling a CI according to an embodiment of the present disclosure is not used is illustrated as NoCIA, and a simulation result in a case that the scheme for controlling the CI according to an embodiment of the present disclosure is used is illustrated as CIA. Here, a CI T_{CI} which is used in a case that the scheme for controlling the CI according to an embodiment of the present disclosure is not used is separately marked in parenthesis. For example, a simulation result in a case that a CI T_{CI} is 2 seconds and the scheme for controlling the CI according to an embodiment of the present disclosure is not used is illustrated as NoCIA (2.0 sec).

As illustrated in FIG. 16, it will be understood that power which is consumed in a case that a CIA scheme according to an embodiment of the present disclosure is used is less than power which is consumed in a case that NoCIA schemes are used in all slave BLE devices.

Further, as described in FIG. 16, it will be understood that variability of channel status and a performance gain of a CIA scheme are increased if a distance between a master BLE device and a slave BLE device is increased.

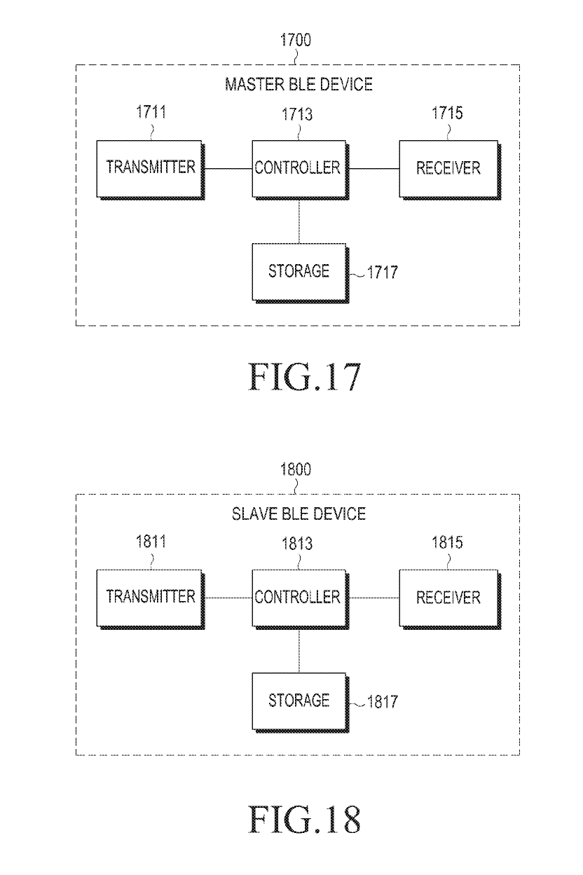

Still another example of a simulation result according to a scheme for controlling a CI in a wireless communication system supporting a Bluetooth scheme according to an embodiment of the present disclosure has been described with reference to FIG. 16, and an inner structure of a master BLE device in a wireless communication system supporting a Bluetooth scheme according to an embodiment of the present disclosure will be described with reference to FIG. 17.

FIG. 17 schematically illustrates an inner structure of a master BLE device in a wireless communication system supporting a Bluetooth scheme according to an embodiment of the present disclosure.

Referring to FIG. 17, a master BLE device 1700 includes a transmitter 1711, a controller 1713, a receiver 1715, and a storage unit 1717.

The controller 1713 controls the overall operation of the master BLE device 1700. More particularly, the controller 1713 controls the master BLE device 1700 to perform an operation related to an operation for controlling a CI in a wireless communication system supporting a Bluetooth scheme according to an embodiment of the present disclosure. The operation related to the operation for controlling the CI in the wireless communication system supporting the Bluetooth scheme according to an embodiment of the present disclosure is performed in the manner described with reference to FIGS. 2 to 16, and a description thereof will be omitted herein.

The transmitter 1711 transmits various signals and various messages, and the like to other devices, e.g., a slave BLE device, and the like included in the wireless communication system under a control of the controller 1713. The various signals, the various messages, and the like transmitted in the transmitter 1711 have been described in FIGS. 2 to 16 and a description thereof will be omitted herein.

The receiver 1715 receives various signals, various messages, and the like from other devices, e.g., a slave BLE device, and the like included in the wireless communication system under a control of the controller 1713. The various signals, the various messages, and the like received in the receiver 1715 have been described in FIGS. 2 to 16 and a description thereof will be omitted herein.

The storage unit 1717 stores a program related to the operation related to the operation for controlling the CI in the wireless communication system supporting the Bluetooth scheme according to an embodiment of the present disclosure which is performed by the master BLE device 1700 under a control of the controller 1713, various data, and the like.

The storage unit 1717 stores the various signals and the various messages which are received by the receiver 1715 from the other devices, and the like.

While the transmitter 1711, the controller 1713, the receiver 1715, and the storage unit 1717 are described in the master BLE device 1700 as separate units, it is to be understood that this is merely for convenience of description. In other words, two or more of the transmitter 1711, the controller 1713, the receiver 1715, and the storage unit 1717 may be incorporated into a single unit. The master BLE device 1700 may be implemented with one processor.

An inner structure of a master BLE device in a wireless communication system supporting a Bluetooth scheme according to an embodiment of the present disclosure has been described with reference to FIG. 17, and an inner structure of a slave BLE device in a wireless communication system supporting a Bluetooth scheme according to an embodiment of the present disclosure will be described with reference to FIG. 18.

FIG. 18 schematically illustrates an inner structure of a slave BLE device in a wireless communication system supporting a Bluetooth scheme according to an embodiment of the present disclosure.

Referring to FIG. 18, a slave BLE device 1800 includes a transmitter 1811, a controller 1813, a receiver 1815, and a storage unit 1817.

The controller 1813 controls the overall operation of the slave BLE device 1800. More particularly, the controller 1813 controls the slave BLE device 1800 to perform an operation related to an operation for controlling a CI in a wireless communication system supporting a Bluetooth scheme according to an embodiment of the present disclosure. The operation related to the operation for controlling the CI in the wireless communication system supporting the Bluetooth scheme according to an embodiment of the present disclosure is performed in the manner described with reference to FIGS. 2 to 16, and a description thereof will be omitted herein.

The transmitter 1811 transmits various signals and various messages, and the like to other devices, e.g., a master BLE device, and the like included in the wireless communication system under a control of the controller 1813. The various signals, the various messages, and the like transmitted in the transmitter 1811 have been described in FIGS. 2 to 16 and a description thereof will be omitted herein.

The receiver 1815 receives various signals, various messages, and the like from other devices, e.g., a master BLE device, and the like included in the wireless communication system under a control of the controller 1813. The various signals, the various messages, and the like received in the receiver 1815 have been described in FIGS. 2 to 16 and a description thereof will be omitted herein.

The storage unit 1817 stores a program related to the operation related to the operation for controlling the CI in the wireless communication system supporting the Bluetooth scheme according to an embodiment of the present disclosure which is performed by the slave BLE device 1800 under a control of the controller 1813, various data, and the like.

The storage unit 1817 stores the various signals and the various messages which are received by the receiver 1815 from the other devices, and the like.

While the transmitter 1811, the controller 1813, the receiver 1815, and the storage unit 1817 are described in the slave BLE device 1800 as separate units, it is to be understood that this is merely for convenience of description. In other words, two or more of the transmitter 1811, the controller 1813, the receiver 1815, and the storage unit 1817 may be incorporated into a single unit. The slave BLE device 1800 may be implemented with one processor.

As is apparent from the foregoing description, an embodiment of the present disclosure enables to control a CI in a wireless communication system supporting a Bluetooth scheme.

An embodiment of the present disclosure enables to adaptively control a CI in a wireless communication system supporting a Bluetooth scheme.

An embodiment of the present disclosure enables to adaptively control a CI based on channel status in a wireless communication system supporting a Bluetooth scheme.

An embodiment of the present disclosure enables to control a CI thereby decreasing power consumption of a BLE device which operates in a BLE mode in a wireless communication system supporting a Bluetooth scheme.

An embodiment of the present disclosure enables to control a CI thereby guaranteeing a seamless connection among BLE devices which operate in a BLE mode in a wireless communication system supporting a Bluetooth scheme.

Certain aspects of the present disclosure may also be embodied as computer readable code on a non-transitory computer readable recording medium. A non-transitory computer readable recording medium is any data storage device that can store data, which can be thereafter read by a computer system. Examples of the non-transitory computer readable recording medium include read only memory (ROM), random access memory (RAM), CD-ROMs, magnetic tapes, floppy disks, optical data storage devices, and carrier waves (such as data transmission through the Internet). The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

It can be appreciated that a method and apparatus according to an embodiment of the present disclosure may be implemented by hardware, software and/or a combination thereof. The software may be stored in a non-volatile storage, for example, an erasable or re-writable ROM, a memory, for example, a RAM, a memory chip, a memory device, or a memory integrated circuit (IC), or an optically or magnetically recordable non-transitory machine-readable (e.g., computer-readable), storage medium (e.g., a compact disk (CD), a digital video disc (DVD), a magnetic disk, a magnetic tape, and/or the like). A method and apparatus according to an embodiment of the present disclosure may be implemented by a computer or a mobile terminal that includes a controller and a memory, and the memory may be an example of a non-transitory machine-readable (e.g., computer-readable), storage medium suitable to store a program or programs including instructions for implementing various embodiments of the present disclosure.

The present disclosure may include a program including code for implementing the apparatus and method as defined by the appended claims, and a non-transitory machine-readable (e.g., computer-readable), storage medium storing the program. The program may be electronically transferred via any media, such as communication signals, which are transmitted through wired and/or wireless connections, and the present disclosure may include their equivalents.

An apparatus according to an embodiment of the present disclosure may receive the program from a program providing device which is connected to the apparatus via a wire or a wireless and store the program. The program providing device may include a memory for storing instructions which instruct to perform a content protect method which has been already installed, information necessary for the content protect method, and the like, a communication unit for performing a wired or a wireless communication with a graphic processing device, and a controller for transmitting a related program to a transmitting/receiving device based on a request of the graphic processing device or automatically transmitting the related program to the transmitting/receiving device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling a connection interval (CI) by a device in a wireless communication system supporting a Bluetooth scheme, the method comprising:
detecting a channel status; and
controlling a CI for a connection that is established between the device and an other device based on the channel status,
wherein the CI denotes an interval during which data packet transmission and data packet reception between the device and the other device are possible.

2. The method of claim 1, wherein the detecting of the channel status comprises detecting the channel status based on a number of data packets that are transmitted by the device and a number of data packets for which acknowledgements (ACKs) will be received.

3. The method of claim 1, wherein the detecting of the channel status comprises estimating the channel status based on round trip time (RTT) of a data packet that is transmitted by the device.

4. The method of claim 1, wherein the controlling of the CI for the connection that is established between the device and the other device based on the channel status comprises:
determining whether a difference between a previous channel status and the channel status is greater than a threshold difference; and
updating the CI if the difference between the previous channel status and the channel status is greater than the threshold difference.

5. The method of claim 4, wherein the controlling of the CI for the connection that is established between the device and the other device based on the channel status further comprises updating a channel status update interval if the difference between the previous channel status and the channel status is greater than the threshold difference.

6. The method of claim 5, further comprising:
setting the detected channel status to the previous channel status.

7. The method of claim 4, further comprising:
awaiting a next channel status update interval if the difference between the previous channel status and the channel status is less than or equal to the threshold difference.

8. The method of claim 4, wherein the updating of the CI if the difference between the previous channel status and the channel status is greater than the threshold difference comprises updating the CI based on power that is consumed during the CI.

9. The method of claim 4, wherein the updating of the CI if the difference between the previous channel status and the channel status is greater than the threshold difference comprises updating the CI based on power that is consumed for transmitting a null packet during the CI and power that is consumed for reestablishing a connection between the device and the other device.

10. The method of claim 4, wherein the updating of the CI if the difference between the previous channel status and the channel status is greater than the threshold difference comprises updating the CI by considering energy that is consumed for transmitting a null packet or receiving a null packet, energy that is consumed for reestablishing a connection between the device and the other device, the CI, and an average supervision timeout interval for the CI, and
wherein an average supervision timeout interval is used for checking whether a connection between two devices is released.

11. A device in a wireless communication system supporting a Bluetooth scheme, the device comprising:
a processor configured to:
detect a channel status, and
control a connection interval (CI) for a connection that is established between the device and an other device based on the channel status,
wherein the CI denotes an interval during which data packet transmission and data packet reception between the device and the other device are possible.

12. The device of claim 11, wherein to detect the channel status, the processor is configured to detect the channel status based on a number of data packets that are transmitted by the device and a number of data packets for that acknowledgements (ACKs) will be received.

13. The device of claim 11, wherein to detect the channel status, the processor is configured to estimate the channel status based on round trip time (RTT) of a data packet that is transmitted by the device.

14. The device of claim 11, wherein to control the CI for the connection that is established between the device and the other device based on the channel status, the processor is configured to:
determine whether a difference between a previous channel status and the channel status is greater than a threshold difference; and
update the CI if the difference between the previous channel status and the channel status is greater than the threshold difference.

15. The device of claim 14, wherein to control the CI for the connection that is established between the device and the other device based on the channel status, the processor is configured to update a channel status update interval if the difference between the previous channel status and the channel status is greater than the threshold difference.

16. The device of claim 15, wherein the processor is further configured to set the detected channel status to the previous channel status.

17. The device of claim 14, wherein the processor is further configured to await a next channel status update interval if the difference between the previous channel status and the channel status is less than or equal to the threshold difference.

18. The device of claim 14, wherein to update the CI if the difference between the previous channel status and the channel status is greater than the threshold difference, the processor is configured to update the CI based on power that is consumed during the CI.

19. The device of claim 14, wherein to update the CI if the difference between the previous channel status and the channel status is greater than the threshold difference, the processor is configured to update the CI based on power that is consumed for transmitting a null packet during the CI and power that is consumed for reestablishing a connection between the device and the other device.

20. The device of claim 14, wherein to update the CI if the difference between the previous channel status and the channel status is greater than the threshold difference, the processor is configured to update the CI by considering energy that is consumed for transmitting a null packet or receiving a null packet, energy that is consumed for reestablishing a connection between the device and the other device, the CI, and an average supervision timeout interval for the CI, and
wherein an average supervision timeout interval is used for checking whether a connection between two devices is released.
